(19) United States
(12) Patent Application Publication
(10) Pub. No.: US 2010/0007943 A1
(43) Pub. Date: Jan. 14, 2010

(54) Optical amplification system and optical amplification method

(75) Inventors: Goji Nakagawa, Kawasaki (JP); Susumu Kinoshita, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/385,841

(22) Filed: Apr. 21, 2009

(30) Foreign Application Priority Data
Jul. 10, 2008 (JP) 2008-180168

(51) Int. Cl. H01S 3/00

(52) U.S. Cl. 359/337.2

(57) ABSTRACT

An optical amplification system includes a wavelength filter that divides a wavelength multiplexing optical signal into a plurality of wavelength multiplexing optical signals having wider wavelength intervals than wavelength intervals of the wavelength multiplexing optical signal, and a first optical amplifier that performs optical amplification on the plurality of divided wavelength multiplexing optical signals independently of one another.

### CROSS-REFERENCE TO RELATED APPLICATION

This application is based upon and claims the benefit of priority of the prior Japanese Patent Application No. 2008-180168, filed on Jul. 10, 2008, the entire contents of which are incorporated herein by reference.

### FIELD

The present invention relates to an optical amplification system and an optical amplification method.

### BACKGROUND

By a wavelength multiplexing method for collectively transmitting optical signals of different wavelengths through one optical fiber, large-capacity optical transmission can be performed. When an optical signal is relayed during the optical transmission, the optical signal is not converted into an electric signal, but is amplified as it is. In this manner, each relay station can be made smaller in size, and the communication costs can be lowered.

When an optical signal of the wavelength multiplexing type is optically amplified, crosstalk such as four-wave mixing might be caused. To counter this problem, Japanese Patent Application Publication No. 11-46029 discloses a technique for dividing each wavelength multiplexing optical signal into signals of different wavelengths, and combining the optical signals of the different wavelengths after optical amplification.

By the technique disclosed in Japanese Patent Application Publication No. 11-46029, however, the number of optically-amplified signals becomes larger, as the number of wavelengths in each wavelength multiplexing optical signal becomes larger. As a result, the production costs become higher.

### SUMMARY

According to an aspect of the present invention, there is provided an optical amplification system including: a wavelength filter that divides a wavelength multiplexing optical signal into a plurality of wavelength multiplexing optical signals having wider wavelength intervals than wavelength intervals of the wavelength multiplexing optical signal; and a first optical amplifier that performs optical amplification on the plurality of divided wavelength multiplexing optical signals independently of one another.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic view illustrating the entire structure of an optical amplification system in accordance with a first embodiment of the present invention;

FIG. 2 is a perspective cross-sectional view illustrating an example stack structure of a SOA;

FIG. 3 is a schematic view illustrating the entire structure of an optical amplification system in accordance with a second embodiment of the present invention; and

FIG. 4 is a schematic view illustrating the entire structure of an optical amplification system in accordance with a third embodiment of the present invention.

### DESCRIPTION OF EMBODIMENTS

The following is a description of embodiments of the present invention, with reference to the accompanying drawings.

### First Embodiment

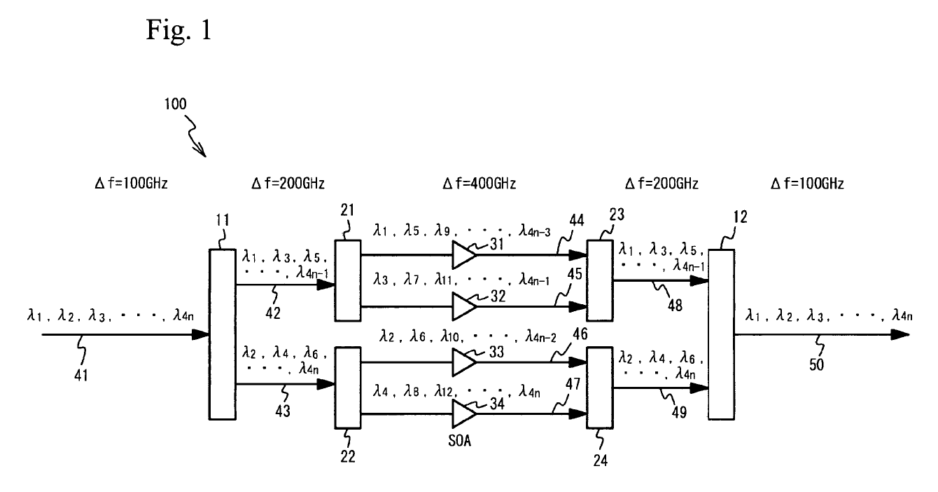

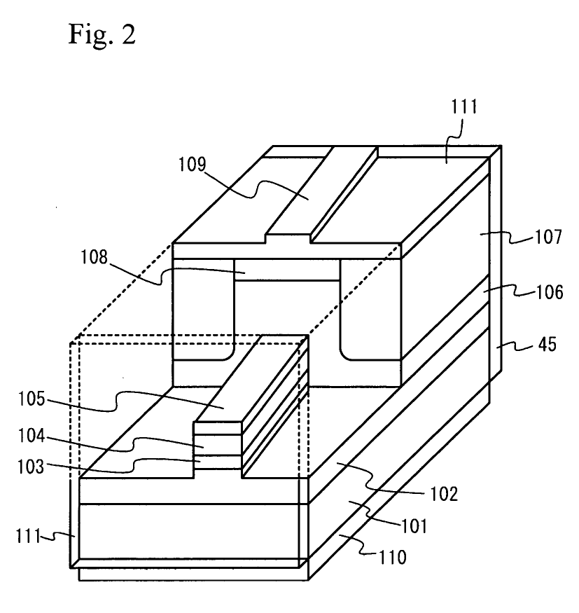

FIGS. 1 and 2 illustrate an optical amplification system 100 in accordance with a first embodiment of the present invention. FIG. 1 is a schematic view illustrating the entire structure of the optical amplification system 100 in accordance with the first embodiment. FIG. 2 is a perspective cross-sectional view illustrating an example stack structure of the later described SOA.

As depicted in FIG. 1, the optical amplification system 100 includes interleave filters 11 and 12, interleave filters 21 through 24, semiconductor optical amplifiers (SOAs) 31 through 34, and optical transmission paths 41 through 50. The SOAs 31 through 34 are equivalent to first optical amplifiers.

The optical transmission paths 41 through 50 are optical fibers, for example. Wavelength multiplexing optical signals are input to the optical transmission path 41. As the wavelength multiplexing optical signals, dense wavelength division multiplexing (DWDM) optical signals may be used. For example, a wavelength multiplexing optical signal formed by multiplexing wavelength signals at 100-GHz intervals in a 1300-nm band is input to the optical transmission path 41. More specifically, a wavelength multiplexing optical signal A is input to the optical transmission path 41 of wavelengths λ₁, λ₂, λ₃, . . . , and λ₄ₙ (n being an integer) at 100-GHz intervals. The end of the optical transmission path 41 is connected to the input end of the interleave filter 11.

The interleave filter 11 is a wavelength filter that divides the wavelength multiplexing optical signal input to the input end into wavelength multiplexing optical signals having wider wavelength intervals than the wavelength intervals of the input wavelength multiplexing optical signal. The interleave filter 11 may be of a multilayer film type or a waveguide type. In this embodiment, the interleave filter 11 divides the wavelength multiplexing signal having the 100-GHz intervals into wavelength multiplexing optical signals having 200-GHz intervals. More specifically, the input wavelength multiplexing optical signal A is divided into a wavelength multiplexing optical signal B1 of wavelengths λ₁, λ₃, λ₅, . . . , and λ₄ₙ₋₁, and a wavelength multiplexing optical signal B2 of wavelengths λ₂, λ₄, λ₆, . . . , and λ₄ₙ. The optical transmission paths 42 and 43 are connected to the output ends of the interleave filter 11. The wavelength multiplexing optical signal B1 is input to the optical transmission path 42. The wavelength multiplexing optical signal B2 is input to the optical transmission path 43. The end of the optical transmission path 42 is connected to the input end of the interleave filter 21. The end of the optical transmission path 43 is connected to the input end of the interleave filter 22.

The interleave filters 21 and 22 are wavelength filters, and each divide the wavelength multiplexing optical signal input to the input end, into wavelength multiplexing optical signals having wider wavelength intervals than the wavelength intervals of the input wavelength multiplexing optical signal. In this embodiment, the interleave filters 21 and 22 divide each wavelength multiplexing optical signal having the 200-GHz intervals into wavelength multiplexing optical signals having 400-GHz intervals.

In this embodiment, the interleave filter 21 divides the wavelength multiplexing optical signal B1 into a wavelength multiplexing optical signal C1 of wavelengths λ₁, λ₅, λ₉, . . . , and λₙ₄₋₃, and a wavelength multiplexing optical signal C2 of wavelengths λ₃, λ₇, λ₁₁, . . . , and λ₄ₙ₋₁. The interleave filter 22 divides the wavelength multiplexing optical signal B2 into a wavelength multiplexing optical signal C3 of wavelengths λ₂, λ₅, λ₁₀, . . . , and λ₄ₙ₋₂, and a wavelength multiplexing optical signal C4 of wavelengths λ₄, λ₈, λ₁₂, . . . , and λ₄ₙ.

The optical transmission paths 44 and 45 are connected to the two output ends of the interleave filter 21. The wavelength multiplexing optical signal C1 is input to the optical transmission path 44. The wavelength multiplexing optical signal C2 is input to the optical transmission path 45. The optical transmission paths 46 and 47 are connected to the two output ends of the interleave filter 22. The wavelength multiplexing optical signal C3 is input to the optical transmission path 46. The wavelength multiplexing optical signal C4 is input to the optical transmission path 47.

The SOA 31 is inserted to the optical transmission path 44. The end of the optical transmission path 44 is connected to one of the two branch ends of the interleave filter 23. The SOA 32 is inserted to the optical transmission path 45. The end of the optical transmission path 45 is connected to the other one of the two branch ends of the interleave filter 23. The SOA 33 is inserted to the optical transmission path 46. The end of the optical transmission path 46 is connected to one of the two branch ends of the interleave filter 24. The SOA 34 is inserted to the optical transmission path 47. The end of the optical transmission path 47 is connected to the other one of the two branch ends of the interleave filter 24.

As depicted in FIG. 2, the SOAs 31 through 34 each have a semiconductor layer stack structure. For example, an n-type InP buffer layer 102 is stacked on an n-type InP substrate 101, and a mesa stripe is placed on the n-type InP buffer layer 102. This mesa stripe has a structure in which an InGaAsP positive bulk activation layer 104 and an InGaAsP optical confinement layer 105 are stacked in this order on an InGaAsP optical confinement layer 103.

A p-type InP buried layer 106 is provided so as to cover the mesa stripe. Proton implantation regions 107 are provided on both sides of the p-type InP buried layer 106. A p-type InGaAs contact layer 108 and a p-side electrode 109 are stacked in this order on the p-type InP buried layer 106. An n-side electrode 110 is provided under the lower face of the n-type InP substrate 101. Non-reflecting films 111 are provided at both ends of the mesa stripe. By applying a voltage between the p-side electrode 109 and the n-side electrode 110, the light guided through the InGaAsP positive bulk activation layer 104 can be amplified.

The interleave filter 23 has the same structure as the interleave filter 21. The interleave filter 24 has the same structure as the interleave filter 22. As wavelength multiplexing optical signals having different wavelengths from each other are input to the branch ends of each of the interleave filters 23 and 24, the interleave filters 23 and 24 function as multiplexers. The interleave filter 23 combines the wavelength multiplexing optical signal C1 and the wavelength multiplexing optical signal C2, to generate the wavelength multiplexing optical signal B1. The interleave filter 24 combines the wavelength multiplexing optical signal C3 and the wavelength multiplexing optical signal C4, to generate the wavelength multiplexing optical signal B2.

The optical transmission path 48 is connected to the output end of the interleave filter 23. The wavelength multiplexing optical signal B1 generated through the multiplexing is input to the optical transmission path 48. The optical transmission path 49 is connected to the output end of the interleave filter 24. The wavelength multiplexing optical signal B2 generated through multiplexing is input to the optical transmission path 49. The end of the optical transmission path 48 is connected to one of the two branch ends of the interleave filter 12. The end of the optical transmission path 49 is connected to the other one of the two branch ends of the interleave filter 12.

The interleave filter 12 has the same structure as the interleave filter 11. As wavelength multiplexing optical signals having different wavelengths from each other are input to the branch ends of the interleave filter 12, the interleave filter 12 functions as a multiplexer. The interleave filter 12 combines the wavelength multiplexing optical signal B1 and the wavelength multiplexing optical signal B2, to generate the wavelength multiplexing optical signal A. The optical transmission path 50 is connected to the output end of the interleave filter 12. The wavelength multiplexing optical signal A generated through the multiplexing is input to the optical transmission path 50.

In this embodiment, each wavelength multiplexing optical signal is caused to have wider wavelength intervals by interleave filters, and is then optically amplified. In this case, crosstalk can be prevented. Since each wavelength multiplexing optical signal does not need to be divided into optical signals of the respective wavelengths in accordance with this embodiment, the number of amplification signals can be reduced. In this case, optical signals can be transmitted with a larger transmission capacity. Also, the number of optical amplifiers can be reduced. Accordingly, an increase in costs can be restrained.

Although each wavelength multiplexing optical signal is divided into four wavelength multiplexing optical signals in this embodiment, the present invention is not limited to that arrangement. If each wavelength multiplexing optical signal is divided into at least two wavelength multiplexing optical signals having wide wavelength intervals, crosstalk can be restrained.

Although SOAs are used as optical amplifiers in this embodiment, the present invention is not limited to that. In a case where optical amplifiers such as SOAs each having a large nonlinear constant and a great optical confining effect are used, four-wave mixing (FWM) between signals easily occurs at a relatively low power level. Therefore, the optical amplification system 100 is particularly effective in a case where SOAs are used.

Furthermore, interleave filters are used as wavelength filters in this embodiment. However, the present invention is not limited to that arrangement, and any wavelength filters that can divide a wavelength multiplexing optical signal into wavelength multiplexing optical signals having wider wavelength intervals may be used as wavelength filters. For example, cyclic AWGs (Arrayed Waveguide Gratings) can be used as wavelength filters.

### Second Embodiment

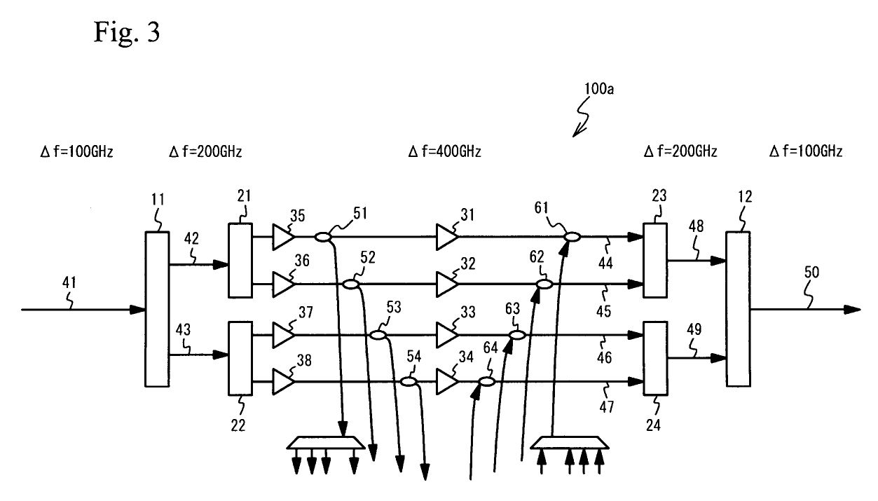

FIG. 3 is a schematic view illustrating the entire structure of an optical amplification system 100a in accordance with a second embodiment of the present invention. In FIG. 3, the same components and usages as those depicted in FIG. 1 are denoted by the same reference numerals as those used in FIG. 1. As depicted in FIG. 3, the optical amplification system 100a further includes optical splitters 51 through 54, SOAs 35 through 38, and optical couplers 61 through 64. The SOAs 35 through 38 function as second optical amplifiers.

The SOA 35 and the optical splitter 51 are inserted in this order to the optical transmission path 44 located between the interleave filter 21 and the SOA 31. The optical coupler 61 is inserted to the optical transmission path 44 located between the SOA 31 and the interleave filter 23. The SOA 36 and the optical splitter 52 are inserted in this order to the optical transmission path 45 located between the interleave filter 21 and the SOA 32. The optical coupler 62 is inserted to the optical transmission path 45 located between the SOA 32 and the interleave filter 23. The SOA 37 and the optical splitter 53 are inserted in this order to the optical transmission path 46 located between the interleave filter 22 and the SOA 33. The optical coupler 63 is inserted to the optical transmission path 46 located between the SOA 33 and the interleave filter 24. The SOA 38 and the optical splitter 54 are inserted in this order to the optical transmission path 47 located between the interleave filter 22 and the SOA 34. The optical coupler 64 is inserted to the optical transmission path 47 located between the SOA 34 and the interleave filter 24.

The SOAs 35 through 38 optically amplify the wavelength multiplexing optical signals C1 through C4, respectively. The optical splitters 51 through 54 split the optically-amplified wavelength multiplexing optical signals C1 through C4, respectively. The optical signals split by the optical splitters 51 through 54 are used as “drop signals”. The optical couplers 61 through 64 are couplers for adding “add signals” to the wavelength multiplexing optical signals C1 through C4, respectively. The SOAs 31 through 34 optically amplify the wavelength multiplexing optical signals C1 through C4 that have passed through the optical splitters 51 through 54.

As the wavelength multiplexing optical signals having wider wavelength intervals are also optically amplified in this embodiment, an increase in costs can be restrained, and crosstalk can also be restrained. When drop signals and add signals are generated, the wavelength multiplexing optical signals having wider wavelength intervals can be used. In this case, inexpensive wavelength filters having wide wavelength intervals can be used as the wavelength filters for generating the drop signals and the add signals. Thus, an increase in costs can be restrained. Furthermore, the SOAs 35 through 38 may be caused to function as wavelength blockers by switching off the SOAs 35 through 38. With this arrangement, it is not necessary to prepare wavelength blockers. Accordingly, the number of required components can be reduced.

### Third Embodiment

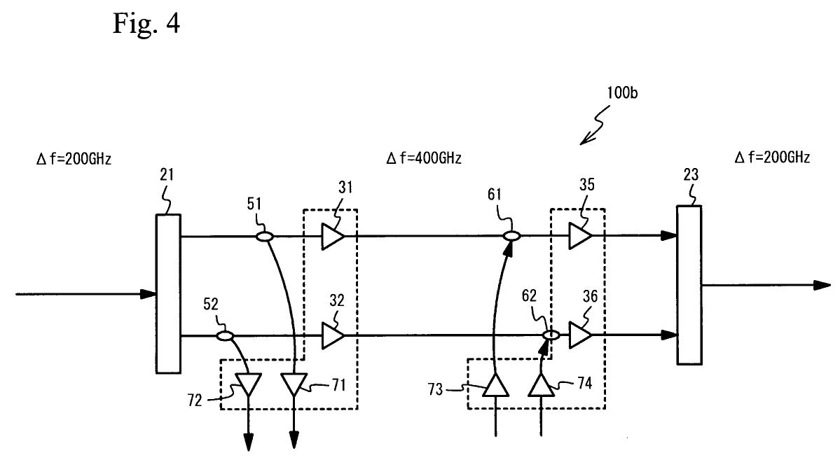

FIG. 4 is a schematic view illustrating the entire structure of an optical amplification system 100b in accordance with a third embodiment of the present invention. In FIG. 4, the same components and usages as those depicted in FIGS. 1 and 3 are denoted by the same reference numerals as those used in FIGS. 1 and 3. Although some of the components located between the interleave filter 21 and the interleave filter 23 are not depicted in FIG. 4, the interleave filters 11 and 12, the interleave filters 22 and 24, and the SOAs 33 and 34 are actually provided as in the optical amplification system 100 depicted in FIG. 1.

As depicted in FIG. 4, in the optical amplification system 100b, optical splitters 51 and 52 are inserted between the interleave filter 21 and the SOAs 31 and 32. A SOA 71 is inserted to an optical transmission path that branches from the optical splitter 51. A SOA 72 is inserted to an optical transmission path that branches from the optical splitter 52. With this arrangement, optical signals that branch from the optical splitters 51 and 52 can be optically amplified.

Optical couplers 61 and 62 are inserted between the SOAs 31 and 32 and the SOAs 35 and 36, respectively. A SOA 73 is inserted to an optical transmission path that is coupled to the optical transmission path 44 by the optical coupler 61. A SOA 74 is inserted to an optical transmission path that is coupled to the optical transmission path 45 by the optical coupler 62.

In this embodiment, the SOAs 31, 32, 71, and 72 are integrally and exchangeably formed into a module. The SOAs 35, 36, 73, and 74 are also integrally and exchangeably formed into a module. If there is a need to exchanges SOAs, the SOAs on the drop side can be exchanged independently of the SOAs on the add side. Accordingly, the exchanging operation becomes easier.

Each of the modules may have an array module structure in which four SOAs are arranged in a line. Here, each SOA has the semiconductor stack structure depicted in FIG. 2. In this case, SOAs are normally manufactured on one semiconductor substrate. In a case where several SOAs are manufactured on a semiconductor substrate, the SOAs are separated from one another in an array fashion by a cleavage method. With the use of modules each having SOAs arranged in an array, there is no need to separate SOAs one by one. Accordingly, the number of manufacturing procedures can be reduced, and the production costs can be lowered.

It is also possible to provide SOAs, optical splitters, and optical couplers between the interleave filter 22 and the interleave filter 24 as in the structure depicted in FIG. 4.

As described so far, in accordance with the above embodiments of the present invention, wavelength multiplexing optical signals are divided into wavelength multiplexing optical signals having wider wavelength intervals, and optical amplification can be performed on the wavelength multiplexing optical signals independently of one another. Accordingly, crosstalk can be restrained. Also, it is not necessary to divide each wavelength multiplexing optical signal into optical signals of the respective wavelengths. Accordingly, the number of amplified optical signals can be reduced. As a result, an increase in costs can be restrained.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An optical amplification system comprising:
a wavelength filter that divides a wavelength multiplexing optical signal into a plurality of wavelength multiplexing optical signals having wider wavelength intervals than wavelength intervals of the wavelength multiplexing optical signal; and
a first optical amplifier that performs optical amplification on the plurality of divided wavelength multiplexing optical signals independently of one another.

2. The optical amplification system as claimed in claim 1, wherein the wavelength filter is formed with one or more interleave filters.

3. The optical amplification system as claimed in claim 1, wherein the wavelength filter is formed with one or more cyclic AWGs.

4. The optical amplification system as claimed in claim 1, wherein the first optical amplifier is a semiconductor optical amplifier.

5. The optical amplification system as claimed in claim 1, further comprising a multiplexer that combines the plurality of divided wavelength multiplexing optical signals after the optical amplification performed by the first optical amplifier.

6. The optical amplification system as claimed in claim 1, further comprising:
an optical splitter that splits each wavelength multiplexing optical signal subjected to the optical amplification performed by the first optical amplifier; and
a wavelength filter that separates the wavelength multiplexing optical signal split by the optical splitter as a drop signal of a single wavelength.

7. The optical amplification system as claimed in claim 6, further comprising an optical coupler that adds a single wavelength signal or a plurality of wavelength signals to the wavelength multiplexing optical signals split by the optical splitter.

8. The optical amplification system as claimed in claim 7, wherein the first optical amplifier is placed between the optical splitter and the optical coupler.

9. The optical amplification system as claimed in claim 6, further comprising a second optical amplifier that is inserted to an optical transmission path that branches from the optical splitter,
wherein the first optical amplifier and the second optical amplifier are formed into a module.

10. The optical amplification system as claimed in claim 9, wherein the first optical amplifier and the second optical amplifier are formed into an array module.

11. An optical amplification method comprising:
dividing a wavelength multiplexing optical signal into a plurality of wavelength multiplexing optical signals having wider wavelength intervals than wavelength intervals of the wavelength multiplexing optical signal; and
performing optical amplification on the plurality of divided wavelength multiplexing optical signals independently of one another.

12. The optical amplification method as claimed in claim 11, wherein the dividing includes dividing the wavelength multiplexing optical signal with the use of a wavelength filter formed with one or more interleave filters.

13. The optical amplification method as claimed in claim 11, wherein the dividing includes dividing the wavelength multiplexing optical signal with the use of a wavelength filter formed with one or more cyclic AWGs.

14. The optical amplification method as claimed in claim 11, wherein the performing optical amplification includes optically amplifying the wavelength multiplexing optical signal with a semiconductor optical amplifier.

15. The optical amplification method as claimed in claim 11, further comprising combining the plurality of divided wavelength multiplexing optical signals after the optical amplification.

16. The optical amplification method as claimed in claim 11, further comprising:
splitting the wavelength multiplexing optical signal subjected to the optical amplifier by the first optical amplifier; and
separating the split wavelength multiplexing optical signal as a drop signal of a single wavelength.

17. The optical amplification method as claimed in claim 16, further comprising adding a single wavelength signal or a plurality of wavelength signals to the split wavelength multiplexing optical signal.

18. The optical amplification method as claimed in claim 17, wherein the optical amplification is performed between the splitting and the adding.
